(19) United States
(12) Patent Application Publication
(10) Pub. No.: US 2026/0177187 A1
(43) Pub. Date: Jun. 25, 2026

(54) INSULATION SPACER AND SYSTEM

(71) Applicant: Integrity Products & Supplies Inc., Sherwood Park (CA)

(72) Inventor: Graham BRIGHAM, Sherwood Park (CA)

(73) Assignee: Integrity Products & Supplies Inc., Sherwood Park (CA)

(21) Appl. No.: 19/016,591

(22) Filed: Jan. 10, 2025

(30) Foreign Application Priority Data
Dec. 24, 2024 (CA) 3260726

(51) Int. Cl. F16L 59/12

(52) U.S. Cl. CPC F16L 59/12

(57) ABSTRACT

An insulation spacer has an insulation body and a plurality of inner surface stand-offs. The insulation body has an outer surface, an inner surface, a first end and a second end. The plurality of inner surface stand-offs are provided in spaced relation to each other and are connected to the inner surface of the insulation body such that the insulation body is spaced from an object to be insulated.

### FIELD OF THE DISCLOSURE

The present application relates generally to an insulation spacer, and more particularly relates to an insulation spacer for high temperature lines.

### BACKGROUND

This section provides background information to facilitate a better understanding of the various aspects of the invention. It should be understood that the statements in this section of this document are to be read in this light, and not as admissions of prior art.

When in operation, thermally insulated pipelines and pipe systems are subject to moisture infiltration as a result of seepage and sweating from condensation. The extent of moisture infiltration that exists within thermal insulation on the pipe system is dependent upon the temperature of the fluid in the pipe, pipe materials, ambient temperatures, and other weather related events including, but not limited to, sudden changes in temperature, fog, rain, and snow. Moisture adjacent to a pipe and insulation can have negative impacts as it results in premature corrosion of pipes and reduced thermal efficacy of insulation. As a result, the insulation may have to be replaced more frequently to maintain thermal performance of the pipe system and reduce the occurrence of corrosion.

### BRIEF SUMMARY

There is provided an insulation spacer that has an insulation body that has an outer surface, an inner surface, a first end and a second end. A plurality of inner surface stand-offs are connected to the inner surface of the insulation body. The plurality of inner surface stand-offs are in spaced relation to each other and space the insulation body from an object to be insulated.

In one embodiment, the plurality of inner surface stand-offs are integrally formed with the insulation body.

In one embodiment, the plurality of inner surface stand-offs each extend from a first end of the insulation body to a second end of the insulation body such that elongated inner surface supports are created.

In another embodiment, each of the plurality of inner surface stand-offs are individual feet.

In one embodiment, the insulation body and the plurality of inner surface stand-offs are made of the same material.

In another embodiment, the insulation body and the plurality of inner surface stand-offs are made of different materials.

In one embodiment, the object to be insulated is a pipe or hose. It will be understood by a person skilled in the art that the object to be insulated may also be process equipment including, but not limited to, pressure vessels, storage tanks, and heat exchangers.

In one embodiment, the insulation body is made of insulation sections.

In one embodiment, the insulation body as a plurality of outer stand-offs positioned on the outer surface of the insulation body such that the insulation body is spaced from a cladding.

In one embodiment, the outer stand-offs each extend from a first end of the insulation body to a second end of the insulation body such that elongated outer supports are created.

In another embodiment, each of the plurality of outer stand-offs are individual feet.

There is also provided an insulation spacer system. The system includes an insulation body having an outer surface, an inner surface, a first end, a second end, and a plurality of inner surface stand-offs in spaced relation to each other connected to the inner surface of the insulation body such that the insulation body is spaced from an object to be insulated. A cladding having an interior surface and an exterior surface is provided and is positioned exterior to the outer surface of the insulation body.

In one embodiment, the plurality of inner surface stand-offs are integrally formed with the insulation body.

In one embodiment, the plurality of inner surface stand-offs each extend from a first end of the insulation body to a second end of the insulation body such that elongated inner surface supports are created.

In another embodiment, each of the plurality of inner surface stand-offs are individual feet.

In one embodiment, the insulation body as a plurality of outer stand-offs positioned on the outer surface of the insulation body such that the insulation body is spaced from the cladding.

In one embodiment, the plurality outer stand-offs each extend from a first end of the insulation body to a second end of the insulation body such that elongated outer supports are created.

In another embodiment, the plurality of outer stand-offs are individual feet.

In one embodiment, the object to be insulated is a pipe or hose. It will be understood by a person skilled in the art that the object to be insulated may also be process equipment including, but not limited to, pressure vessels, storage tanks, and heat exchangers.

In one embodiment, the insulation body is made of insulation sections.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a perspective view of an insulation spacer system.

FIG. 2 is an end elevation view of the insulation spacer system of FIG. 1.

FIG. 3 is a perspective view of an insulation spacer.

FIG. 4 is an end elevation view of the insulation spacer of FIG. 3.

FIG. 5 is a perspective view of a variation of an insulation spacer.

FIG. 6 is an end elevation view of the insulation spacer shown in FIG. 5.

FIG. 7 is a perspective view of a second variation of an insulation spacer.

FIG. 8 is a perspective view of a third variation of an insulation spacer.

FIG. 9 is an end elevation view of the insulation spacer shown in FIG. 8.

FIG. 10 is a perspective view of a fourth variation of an insulation spacer.

### DETAILED DESCRIPTION OF THE PREFERRED EMBODIMENTS

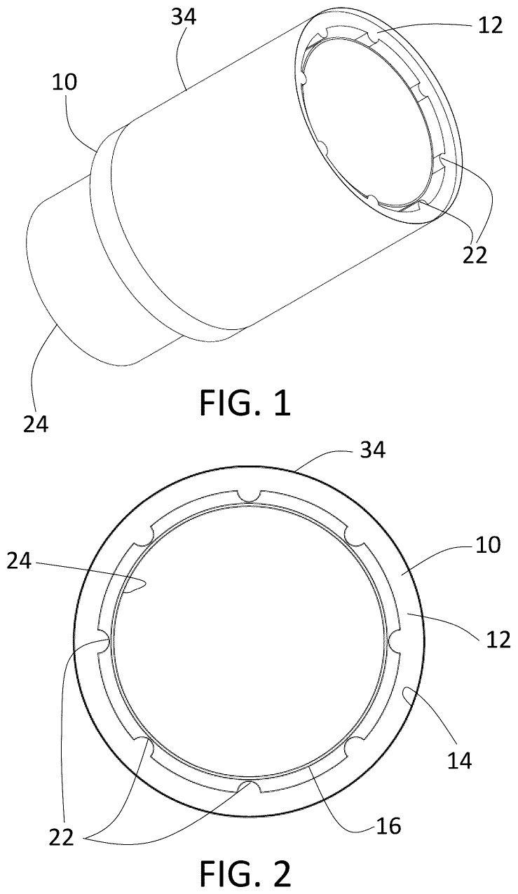

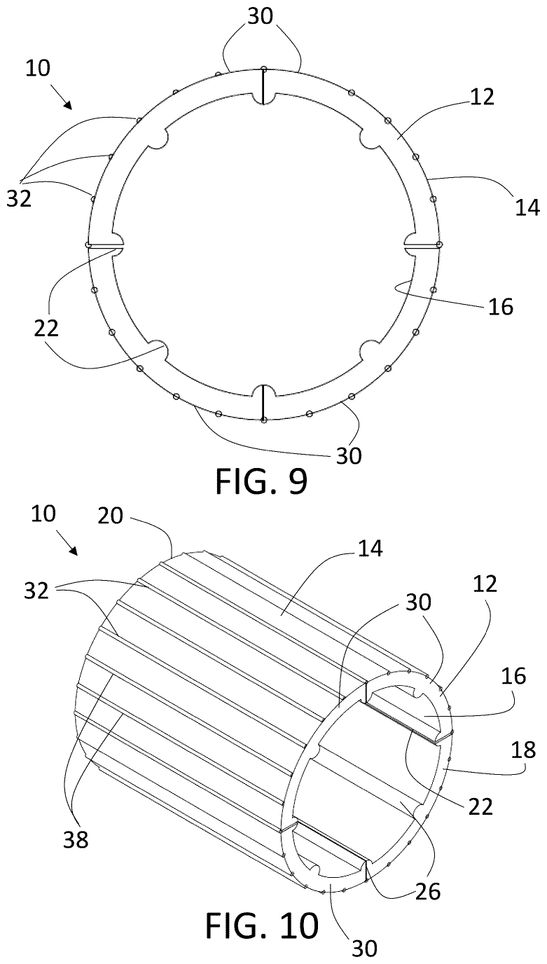

An insulation spacer, generally identified by reference numeral 10, will now be described with reference to FIG. 1 through FIG. 10.

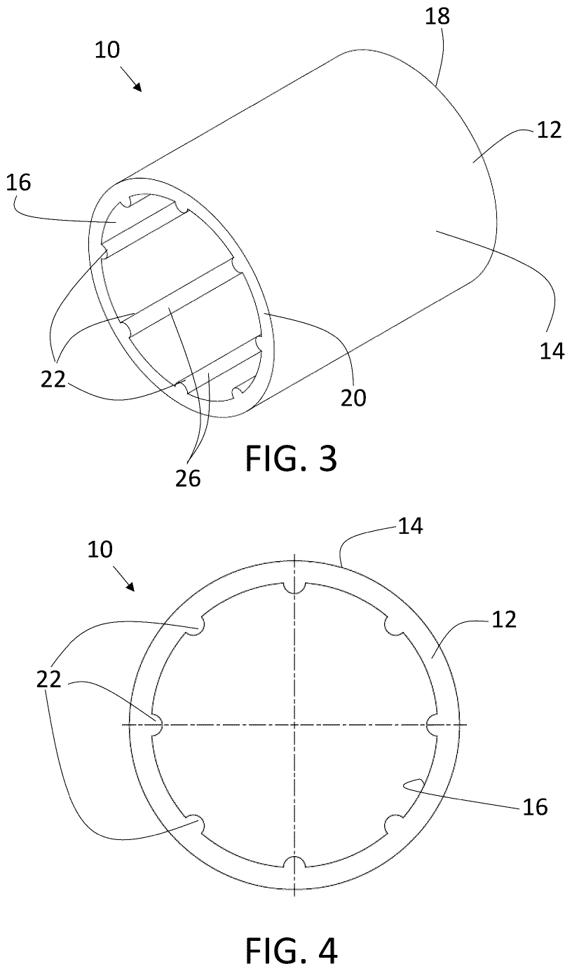

Insulation spacer 10 may be used in both high temperature and low temperature insulation systems. Referring to FIG. 3, insulation spacer 10 has an insulation body 12 that has an outer surface 14, an inner surface 16, a first end 18, and a second end 20. Insulation body 12 may be made of any suitable insulation material known to a person skilled in the art including, but not limited to, fibrous insulation such as stone wool and cellular glass, flexible blankets, rigid insulation such as expanded perlite, calcium silicate, and foam glass, or a combination of these and other insulation materials. Insulation body 12 may be any width suitable for providing insulation. The width of insulation body 12 is generally dictated by the type of material used, the purpose of the insulation, and the preference of the user. In one embodiment, insulation body 12 has a thickness of 0.5 inches to 6 inches.

A plurality of inner surface stand-offs 22 are provided in spaced relation to each other. Inner surface stand-offs 22 may be made of the same material as insulation body 12 or may be made of different materials. When made of the same material as insulation body 12, inner surface stand-offs 22 may be integrally formed with insulation body 12. By being integrally formed, there is no risk of disconnection between insulation body 12 and inner surface stand-offs 22. It will, however, be understood by a person skilled in the art that inner surface stand-offs 22 and insulation body 12 do not need to be integrally formed. Inner surface stand-offs 22 are preferably not made of metal prone to corrosion as this could unintentionally speed up corrosion on an insulated system. Inner surface stand-offs 22 are connected to inner surface 16 of insulation body 12 such that insulation body 12 is spaced from an object to be insulated 24, shown in FIG. 1 and FIG. 2. Space between insulation body 12 and object to be insulated 24 helps to shed and breath out the moisture along with reducing the oxygen concentration cells at the interface between insulation body 12 and object to be insulated 24, thereby reducing the corrosion risk. In addition to providing corrosion mitigation, inner stand-offs 22 reduce heat transfer from object to he insulated 24 to insulation body 12.

Referring to FIG. 2, the space between insulation body 12 and object to be insulated 24 may be any size deemed suitable by a person skilled in the art. In one embodiment, insulation body 12 is spaced 0.2 inches to 1 inch from object to be insulated 24. While maintaining the same about of space between insulation body 12 and object to be insulated 24 may be beneficial, the amount of space between these may vary in a single application. Variation in the amount of space is more likely to be seen where a highly flexible insulation body 12 is used as it would be expected that some sagging towards and away from the object to be insulated 24 could be expected. In the embodiment shown in FIG. 1 and FIG. 2, object to be insulated 24 is a pipe. It will be understood by a person skilled in the art that object to be insulated may include, but is not limited to, hoses, pipelines, plumbing pipes, pipes for other purposes, boilers, vessels, heat exchangers, storage tanks and heaters.

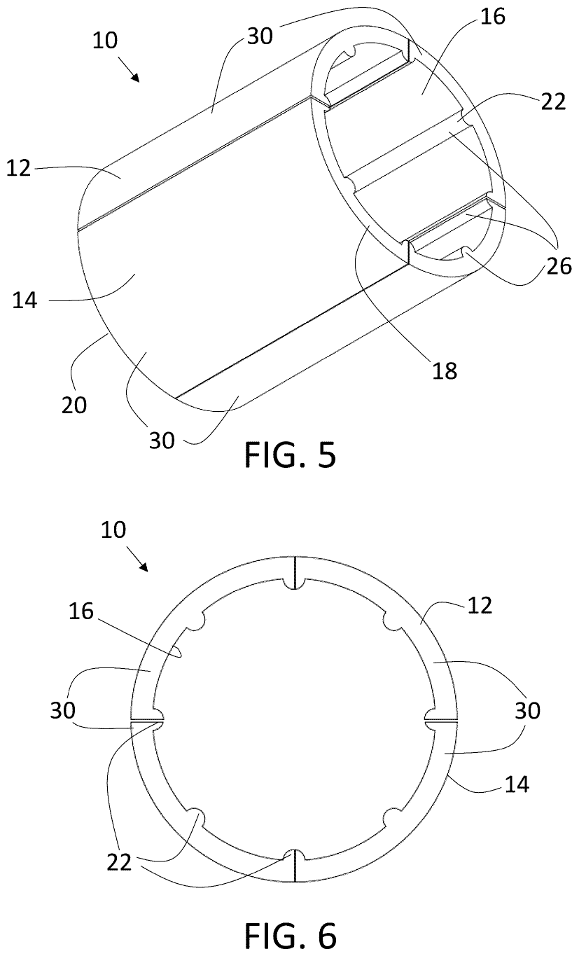

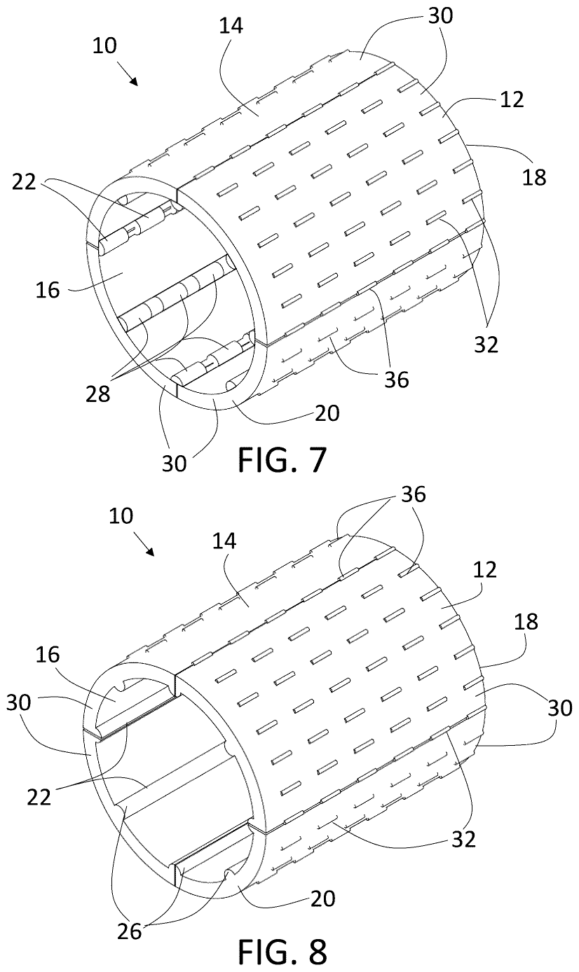

Inner surface stand-offs 22 may be any suitable size or shape to create a space between insulation body 12 and object to be insulated. Spacing between adjacent inner surface stand-offs 22 is dependent upon the flexibility of the material used to make insulation body 12. A more flexible insulation body 12 will require more closely spaced inner surface stand-offs 22 to maintain a space between insulation body 12 and object to be insulated 24 than a more rigid insulation body 12 which may require as few as two inner surface stand-offs 22 spaced with a greater distance between them. In the embodiment shown in FIG. 3, FIG. 5, and FIG. 8, plurality of inner surface stand-offs 22 each extend from first end 18 to second end 20 of insulation body 12 such that a plurality of elongated inner surface supports 26 are created. In the embodiment shown in FIG. 7, each of the plurality of inner surface stand-offs 22 are individual feet 28. The specific size and shape of feet 28 may be determined by a person skilled in the art given the specific requirements of the insulation system. Feet 28 may be concave, convex, or any shape suitable for a person skilled in the art. In the embodiment shown, individual feet 28 are aligned both with each other, however it will be understood by a person skilled in the art that individual feet 28 may be spaced in any suitable pattern that creates a space between insulation body 12 and object to be insulated 24. In the embodiments shown, inner surface stand-offs 22 are spaced equidistant from each other, however it will be understood by a person skilled in the art that inner surface stand-offs 22 may be spaced irregular distances from each other. It will be understood by a person skilled in the art that a combination of elongated inner surface supports 26 and individual feet 28 may make up inner surface stand-offs 22.

In the embodiments shown in FIG. 5 through FIG. 9, insulation body 12 is made of a plurality of insulation sections 30. The use of insulation sections 30 are most beneficial when insulation body 12 is made of a rigid material as it allows for the placement of insulation sections 30 around object to be insulated 24 without the risk of breaking insulation body 12 or having to slide insulation body 12 from one end of object to be insulated 24 to the correct position for insulation body 12. It will be understood by a person skilled in the art that the number of insulation sections 30 that make up insulation body 12 may vary depending upon the size and shape of insulation body 12, the size and shape of object to be insulated 24, and user preference.

In the embodiments shown in FIG. 7 through FIG. 10, insulation body 12 has a plurality of outer stand-offs 32 positioned on outer surface 14 of insulation body such that insulation body 12 is spaced from a cladding 34, shown in FIG. 1 and FIG. 2. It will be understood by a person skilled in the art that cladding is the common term for the outer layer of insulation systems. Other synonymous terms, such as jacketing, are also used by a person skilled in the art and reference the same outer layer. In the embodiments shown in FIG. 7 and FIG. 8, outer stand-offs 32 are individual outer feet 36. The specific size and shape of outer feet 36 may be determined by a person skilled in the art given the specific requirements of the insulation system. Feet 36 may be concave, convex, or any shape suitable for a person skilled in the art. In the embodiment shown, individual outer feet 36 are aligned both with each other, however it will be understood by a person skilled in the art that individual outer feet 36 may be spaced in any suitable pattern that creates a space between insulation body 12 and cladding 34. In the embodiment shown in FIG. 10, plurality of outer stand-offs 32 each extend from first end 18 to second end 20 of insulation body 12 such that a plurality of elongated outer surface supports 38 are created. In the embodiments shown, outer surface stand-offs 32 are spaced equidistant from each other, however it will be understood by a person skilled in the art that outer surface stand-offs 32 may be spaced irregular distances from each other. As with inner stand-offs 22, outer stand-offs 32 create an air gap or air gaps between insulation body 12 and cladding 34. It will be understood by a person skilled in the art that a combination of elongated outer surface supports 38 and individual feet 36 may make up outer surface stand-offs 32.

Through the use of insulation body 12, cladding 34, and any other suitable vents, drains, or products, such as the Perforated Dimpled Wrap and Spacer Wrap made by Integrity Products & Supplies Inc. of Alberta Canada, designed to assist in moisture and corrosion management within an insulated system, it is possible to reduce corrosion on the objects to be insulated 24, damage to insulation material, and damage to the overall insulated system. Inner stand-offs 22 and outer stand-offs 32 are designed to provide direct contact to object to be insulated 24 and cladding, respectively. However, it will be understood by a person skilled in the art that other products may be positioned between insulation body 12 and object to be insulated 24 and insulation body 12 and cladding 34.

Inner stand-offs 22 and outer stand-offs 32 on insulation body 12 are meant to achieve the shedding and breath out of moisture, along with reducing the oxygen concentration cells at the insulation metal interface, thereby reducing the corrosion risk under thermal insulations. The insulation metal interface is the point at which inner stand-offs 22 contact object to be insulated 24. In addition to providing corrosion mitigation, inner stand-offs 22 reduce heat transfer from object to be insulated 24 by reducing thermal conduction that otherwise exists with insulation held in contact with object to be insulated.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. An insulation spacer, comprising:
an insulation body having an outer surface, an inner surface, a first end and a second end;
a plurality of inner surface stand-offs in spaced relation to each other connected to the inner surface of the insulation body such that the insulation body is spaced from an object to be insulated.

2. The insulation spacer of claim 1 wherein the plurality of inner surface stand-offs are integrally formed with the insulation body.

3. The insulation spacer of claim 1 wherein the plurality of inner surface stand-offs each extend from the first end of the insulation body to the second end of the insulation body such that a plurality of elongated inner surface supports are created.

4. The insulation spacer of claim 1 wherein each of the plurality of inner surface stand-offs are individual feet.

5. The insulation spacer of claim 1 wherein the insulation body and the plurality of inner surface stand-offs are made of the same material.

6. The insulation spacer of claim 1 wherein the insulation body and the plurality of inner surface stand-offs are made of different materials.

7. The insulation spacer of claim 1 wherein the object to be insulated is a pipe, hose, pressure vessel, storage tank or heat exchanger.

8. The insulation spacer of claim 1 wherein the insulation body is made of a plurality of insulation sections.

9. The insulation spacer of claim 1 wherein the insulation body has a plurality of outer stand-offs positioned on the outer surface of the insulation body such that the insulation body is spaced from a cladding.

10. The insulation spacer of claim 9 wherein the outer stand-offs each extend from the first end of the insulation body to the second end of the insulation body such that a plurality of elongated outer supports are created.

11. The insulation spacer of claim 9 wherein each of the plurality outer stand-offs are individual outer feet.

12. An insulation spacer system, comprising:
an insulation body having an outer surface, an inner surface, a first end, a second end and a plurality of inner surface stand-offs in spaced relation to each other connected to the inner surface of the insulation body such that the insulation body is spaced from an object to be insulated;
a cladding having an interior surface and an exterior surface, the cladding being positioned exterior to the outer surface of the insulation body.

13. The insulation spacer system of claim 12 wherein the plurality of inner surface stand-offs are integrally formed with the insulation body.

14. The insulation spacer system of claim 12 wherein the plurality of inner surface stand-offs each extend from a first end of the insulation body to a second end of the insulation body such that elongated inner surface supports are created.

15. The insulation spacer system of claim 12 wherein the plurality of inner surface stand-offs are individual feet.

16. The insulation spacer system of claim 12 wherein the insulation body has a plurality of outer stand-offs positioned on the outer surface of the insulation body such that the insulation body is spaced from the cladding.

17. The insulation spacer of claim 16 wherein the plurality of outer stand-offs each extend from the first end of the insulation body to the second end of the insulation body such that a plurality of elongated outer supports are created.

18. The insulation spacer of claim 16 wherein each of the plurality of outer stand-offs are individual outer feet.

19. The insulation spacer system of claim 12 wherein the object to be insulated is a pipe, hose, pressure vessel, storage tank or heat exchanger.

20. The insulation spacer system of claim 12 wherein the insulation body is made of insulation sections.
